(19) United States
(12) Patent Application Publication
(10) Pub. No.: US 2006/0011544 A1
(43) Pub. Date: Jan. 19, 2006

(54) Membrane purification system

(76) Inventors: Sunity Sharma, Fremont, CA (US); Subhash C. Narang, Palo Alto, CA (US); Lawrence Dubois, Palo Alto, CA (US); Anoop Nagar, Palo Alto, CA (US); Donald Schleich, Nantes (FR)

Correspondence Address: REED INTELLECTUAL PROPERTY LAW GROUP, 1400 PAGE MILL ROAD, PALO ALTO, CA, 94304-1124, US

(21) Appl. No.: 11/083,381

(22) Filed: Mar. 16, 2005

Related U.S. Application Data
(60) Provisional application No. 60/553,734, filed on Mar. 16, 2004.

(51) Int. Cl. B01D 61/36

(52) U.S. Cl. 210/640; 210/641; 210/650; 210/651; 210/652; 210/490; 210/321.84; 210/321.72; 210/645; 210/646; 210/335

(57) ABSTRACT

A membrane purification system and method are described in which a first membrane, an osmotically active agent, and a second membrane are utilized to separate fluid components. In general, fluid is moved through the first membrane into an osmosis compartment containing the osmotically active agent by the osmotic force of an osmotically active agent disposed between the first membrane and the second membrane. The fluid is forced from the osmotically active agent and through the second membrane while the second membrane retains the osmotically active agent in the osmosis compartment. The osmotically active agent may include a polymer.

### CROSS-REFERENCE TO RELATED APPLICATIONS

This application claims priority under 35 U.S.C. § 119(e)(1) to Provisional U.S. Patent Application Ser. No. 60/553,734, filed Mar. 16, 2004. The disclosure of the aforementioned application is incorporated by reference in its entirety.

### STATEMENT OF GOVERNMENT INTEREST

This invention was funded in part with Government support under Contract No. NBCHC—O₂-0065 awarded by the U.S. Department of Interior, National Business Center. The Government has certain rights in this invention.

### TECHNICAL FIELD

This invention relates generally to semi-permeable membrane-based separations and, more particularly, to semi-permeable polymeric membrane-based water purification.

### BACKGROUND OF THE INVENTION

Numerous methods and devices for removal or destruction of contaminants from water and other fluids are well known in the art. Depending on the particular contaminant and desired clean water volume, suitable configurations and methods range from relatively simple devices (e.g., filters) to highly complex machines (e.g., micro droplet evaporative desalination).

Recent advances in membrane separation have, for example, significantly improved the ability to purify fluids such as water without increasing the complexity of the separation systems. For example, numerous portable and relatively simple systems are available in which a fluid such as water from a contaminated source is passed through an ultrafiltration membrane using pressure provided by a manually operated pump. While such systems generally provide a user with potable water in a relatively short period of time, they often have several disadvantages as well. Among other things, ultrafiltration membranes tend to clog rapidly; this is especially so where the contaminated water has a relatively high colloid content. Moreover, as the pore size of the ultrafiltration membrane decreases, the pressure required for effective filtration increases. Ultrafiltration devices also often fail to remove small pathogens (e.g., viruses, toxins, etc.) from a water source.

Alternatively, and especially where small ionic species are to be removed from a water source, electrodialysis may be employed in which an electric current between two electrodes drives positively and negatively charged contaminants (e.g., mineral salt ions) through semi-permeable cationic and anionic membranes that retain the water, thus decreasing the content of ionic species between the membranes. When this process is repeated several times, relatively pure water can be obtained. Variations on this process and further modifications are described in U.S. Pat. No. 6,673,249. While such systems are relatively effective in desalination, energy requirements are often relatively high. In addition, where the contaminants are electrically neutral, removal of such contaminants is often problematic. Most electrodialysis systems also require a pre-purification step before the water is passed between the electrodes, thereby increasing the cost and complexity.

Reverse osmosis systems are also employed for large volume desalination of brackish water or even sea water. Typical reverse osmosis systems for water purification are described in U.S. Pat. No. 6,656,352 to Bosley, or U.S. Pat. No. 6,607,668 to Rela. Reverse osmosis can be performed on a relatively large scale, and can produce considerable amounts of purified/desalinated water. However, due to the movement of the water against osmotic pressure, relatively large quantities of energy are required for water purification. As considerable pressure is applied to force the water through a reverse osmosis membrane assembly, such devices are typically rigid and relatively heavy-weight structures.

Alternatively, forward osmosis may be implemented to circumvent at least some of the problems associated with reverse osmosis. In such systems, water or another fluid travels in the direction of the osmotic pressure, thereby allowing construction of relatively lightweight, flexible devices. Typical forward osmosis systems are described in U.S. Pat. No. 6,391,205 to McGinnis. In some of the known systems, e.g., as developed by Hydration Technology, high concentrations of salt and/or glucose act as a high-osmolality component that is separated from a contaminated water source by hydrophilic nanoporous membranes with a pore diameter of about 5 Angstroms. Such systems are especially advantageous as the small pore diameter allows removal of even the smallest viral particles, and most toxins. However, as the water moves towards the high-osmolality component, the salt and glucose is dissolved and the forward osmosis filtrate therefore contains relatively high amounts of salt and/or glucose. While the filtrate in such devices is generally fit for human consumption, such forward osmosis devices will in most cases fail to directly provide pure water and include some of the high-osmolality component.

One such forward osmosis system is described in U.S. Pat. No. 6,849,184 (issued Feb. 1, 2005 to Lampi et al., and assigned to Hydration Technologies) in which a forward osmosis pressurized device and one hydraulically coupled to a reverse osmosis membrane is used to generate potable water, particularly from water having a high salt content. Passive systems based on forward osmosis have also been commercially developed and marketed as reported in news articles (e.g., HydroPack and X-Pack hydration system from Hydration Technologies). However, some concern has been raised in reports about these devices for particular uses, such as military use, since the weight savings, long delay period in providing potable water, and ability to remove smaller pathogens such as the Hepatitis-A virus may compromise the effectiveness of the devices in the field.

Therefore, while numerous membrane-based systems, both large and small scale, and methods for fluid and water purification are known in the art, all or almost all of them suffer from one or more disadvantages. In one regard, there is a continuing need for simple and portable devices that provide clean fluids such as water without relatively complex and/or energy-demanding structures. Thus, a need remains for improved membrane-based fluid, and particularly water, purification systems.

### SUMMARY OF THE INVENTION

The present invention is addressed to the aforementioned needs in the art, and provides a novel approach to membrane-based separation and/or purification of fluids and concerns both a membrane system for the purification of a fluid and a method of purifying a fluid using a membrane system.

In one aspect, the invention is directed to a system for the purification of a fluid in which a first semi-permeable membrane is fluidly coupled to a second semi-permeable membrane, such that fluid is moved through the first membrane by the osmotic force of an osmotically active agent disposed between the first membrane and the second membrane, and wherein the fluid is forced from the osmotically active agent and moved through the second membrane. The osmotically active agent functions to force the fluid through the first membrane into, for example, an osmosis compartment, from which the fluid is then forced through the second membrane. The osmotically active agent is generally retained by the second membrane from passage through the membrane, e.g. in the osmosis compartment, while the purified fluid passes through the second membrane as permeate.

In an alternate aspect, a fluid purification system according to the invention includes a first semi-permeable membrane that separates a fluid source from an osmosis compartment comprising an osmotically active agent, and a second membrane that separates the osmosis compartment from a permeate compartment, wherein the osmotically active agent provides sufficient osmolarity to move fluid from the fluid source through the first membrane to the osmosis compartment, and wherein the second membrane allows the fluid from the osmosis compartment to pass to the permeate compartment while retaining the osmotically active agent.

The invention further includes a method of purifying a fluid in which a fluid is forced from a fluid source through a first membrane into an osmosis compartment using the osmotic force of an osmotically active agent. In another step, the fluid is forced from the osmosis compartment through a second membrane into a permeate compartment, while the osmotically active agent is retained in the osmosis compartment.

Various objects, features, aspects and advantages of the present invention will become more apparent from the following detailed description of the invention.

### BRIEF DESCRIPTION OF THE DRAWINGS

FIG. 1 illustrates a schematic of an exemplary water purification system.

FIG. 2 is a more detailed schematic of an exemplary water purification system.

FIG. 3 is one configuration of an exemplary water purification system.

FIG. 4 is another configuration of an exemplary water purification system.

FIG. 5 is a further configuration of an exemplary water purification system.

FIG. 6 is a photograph of a model of an exemplary water purification system.

### DETAILED DESCRIPTION OF THE INVENTION

The present invention is based in part on the discovery that fluids can be purified in a simple and highly effective manner from a contaminated or other fluid source using a membrane system that allows separation of the fluid from an osmotically active agent. Suitable devices employing an osmotically active agent allow for fluid recovery, such as water, from the osmotically active agent using an applied force. Typically, though not necessarily, the applied force is a mechanical force or pressure exerted on the osmotically active agent. For small scale devices based on the invention, the mechanical force may be the manual force exerted by an individual operating a pump or other device that applies a force to the osmotically active agent. In larger membrane systems, including membrane systems connected in series, the applied force is typically produced by a machine or other mechanical device capable of exerting forces greater than an individual might produce.

The term “forward osmosis” as used herein refers to transport of water through a semi-permeable membrane in direction of an osmotic potential. As also used herein, the term “semi-permeable membrane” refers to all membranes that selectively allow passage of water across the membrane, but substantially block transport of molecules other than a particular fluid such as water (with a molecular weight typically greater than the fluid). As still further used herein, the term “forward osmosis membrane” refers to any semi-permeable membrane with an average pore size of less than 50 nm, more typically less than 10 nm, even more typically less than 5 nm, and most preferably less than 1 nm. Therefore, under the terms of this definition, fluid will travel in a forward osmosis system from a location of lower osmolarity to a location of higher osmolarity.

As used herein, the term “reverse osmosis” refers to pressure driven transport of water through a semi-permeable membrane in opposition to an osmotic potential. The fluid will travel in a reverse osmosis system from a location of higher osmolarity to a location of lower osmolarity, so long as sufficient force is applied to the fluid on the location of higher osmolarity.

The term “membrane distillation,” as used herein, refers to the known unit operation in which a membrane distillation membrane, typically a hydrophobic membrane, is used to separate a fluid such as water by the transport of a vapor of the fluid (e.g. water vapor) through the membrane. Both a feed and permeate solution are usually in contact with the membrane, which allows passage of the vapor, but not liquid, through the membrane. Typically, an imposed temperature difference between the feed and permeate solutions gives rise to a transmembrane pressure difference that drives the vapor flux across the membrane.

The term “osmotic distillation” generally also refers to the known unit operation in which an osmotic distillation membrane functions as a vapor barrier between feed and permeate liquid phases such that a vapor of the feed fluid, e.g. water, moves across the osmotic distillation membrane as a vapor and condenses on the permeate side of the membrane. As is generally understood, the driving force for mass transport of the fluid vapor across the membrane results from the differences in vapor pressures of the feed and permeate liquid phases. As is also known, osmotic distillation processes have been utilized in concentrating food and pharmaceutical products, and allow a fluid such as water to be separated from other components present in the feed such as volatile organics.

As still further used herein, the term “osmotically active agent” refers to any agent that is capable of generating an osmotic potential. Preferred osmotically active agents include polymers and those compounds that dissociate into a plurality of ions upon contact with water. It is generally desirable that the molecular weight of at least one ionic species of the osmotically active agent is at least 10 times, more typically at least 100 times, and most typically at least 1000 times the molecular weight of water.

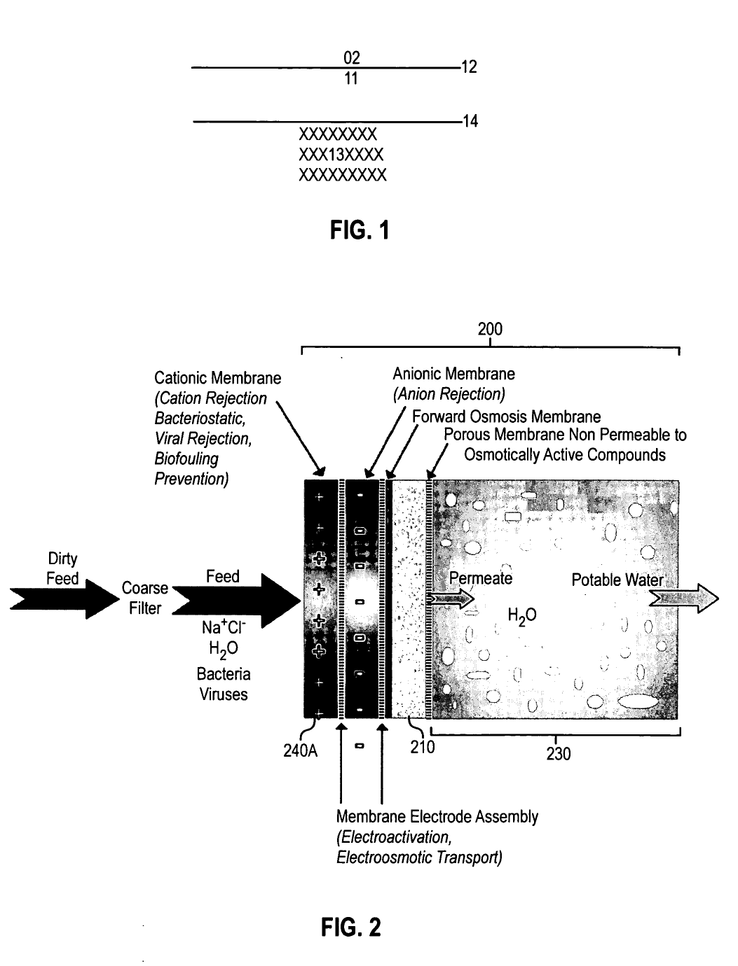

As schematically shown in FIG. 1, 12 is a forward osmosis membrane separating a fluid source such as a contaminated water source 02 from osmotically active agent 11. Fluid, in this case water, permeates under osmotic pressure into the osmosis compartment that is formed between the forward osmosis membrane 12 and the ultrafiltration membrane 14. Ultrafiltration membrane 14 separates the osmotically active agent 11 from permeate compartment 13. Water is transported through ultrafiltration membrane 14 under mechanical force applied either on the osmosis compartment (for example manual, pump, pneumatic, electrical potential) and/or on permeate compartment side (for example sponge action, suction, capillary action, vacuum). Alternatively, mechanical pulses such as vibrations can be applied to increase the fluid or water flux.

Alternatively, as shown in water purification system 200 of FIG. 2, the ultrafiltration membrane 12 of FIG. 1 may be replaced with a membrane-electrode coupled to a forward osmosis membrane. The water purification system 200 has an osmosis compartment 210 (comprising a polymer as an osmotically active agent) and a permeate compartment 230 that is separated from the osmosis compartment by a porous semi-permeable membrane, that is non-permeable to osmotically active agents. System 200 further includes a positively charged semi-permeable membrane 240A that is coupled to a negatively charged semi-permeable membrane 240B, wherein the negatively charged semi-permeable membrane 240B is sandwiched between an anode and a cathode. Anode and cathode are activated by a power source (not shown) using timed electric pulses to effect micro-oscillation of the water in the osmosis compartment.

Such membrane assemblies are thought to be particularly advantageous in removal of ionic species, and/or exhibit bacteriostatic properties, and/or viral rejection characteristics. In other aspects, at least one of the membranes may be derivatized with a functional group that interacts with a component present in the water. For example, the functional group may be especially configured to capture a toxin, or other undesirable component.

Thus, fluid such as water from a contaminated source will move across the forward osmosis membrane by virtue of the relatively high osmotic potential of the osmotically active agent disposed between the forward osmosis membrane and the second membrane. As is typical for a forward osmosis system, the flux of the fluid is in the direction of the osmotic potential and is thus at least in part determined by diffusion. Under these circumstances, even a highly contaminated fluid will not (or will only to a relatively insignificant degree) clog the pores in the forward osmosis membrane. Once the fluid is in the osmosis compartment, the application of force (e.g., mechanical force, or, in the case of small scale devices, manual force) is in most circumstances sufficient to remove the fluid from the osmotically active agent through a semi-permeable membrane, which may be, e.g., an ultrafiltration membrane, a microfiltration membrane, or other suitable membrane (further discussed below).

As an additional unique benefit of the present invention, the osmotically active agent, e.g. a polymer, may be recycled for use in the separation of the fluid from the fluid source by the first membrane. A reduction in operating costs may therefore be realized by eliminating or at least reducing the need for replenishing any of the osmotically active agent that might be lost from the membrane system.

It should also be noted that the membrane purification system of the invention is not limited to a particular scale or size and may be arranged in any configuration known in the art. Such systems range, for example, from small devices suitable for use by an individual in which manual force may be applied to force the fluid from the osmotically active agent through the second membrane to large scale systems in which mechanical or other force is necessary. The membrane system may also be arranged in a series or other configuration, as is known in the art, in order to selectively separate various components from a feed source, or to successively purify a product stream.

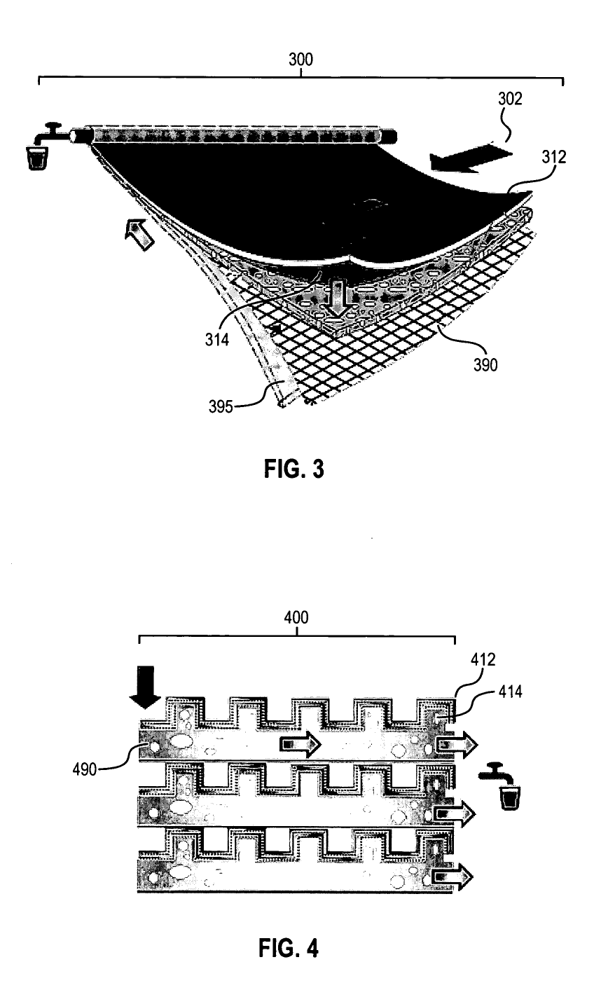

Fluid purification systems according to the invention, particularly water purification systems, may be manufactured from flexible material (i.e., material that can be deformed using manual force), and may be formed into a spiral configuration and/or stacked as depicted in FIGS. 3 and 4, respectively. Other configurations known in the art may also be utilized such as flat plate, spiral, and sandwich, including hollow-fiber and composite membranes.

In the system of FIG. 3, fluid (water) from contaminated feed 302 passes through forward osmosis membrane 312 and ultrafiltration membrane 314 into the permeate compartment 390 comprising a hydrophilic sponge-like material and a mesh or channels. Backing 395 separates the layers as the device is rolled up into a spiral configuration. Similarly, as depicted in device 400 of FIG. 4, the water of contaminated feed 402 passes through forward osmosis membrane 412 and ultrafiltration membrane 414 to the permeate compartment 490.

In preferred water purification systems, the first membrane that separates the fluid (water) source from the osmotically active agent is a forward osmosis membrane with an average pore size of less than 1 nm. Various forward osmosis membranes are known in the art and/or are commercially available (e.g., Hydration Technologies Inc.), and all of such membranes are considered suitable for use herein. Thinner membranes (i.e., less than 1 mm, and more typically less than 100 μm) are in most circumstances preferred over thicker membranes (i.e., equal or more than 1 mm), as the fluid movement may be characterized as predominantly diffusion as opposed to pressure driven filtration. Consequently, where high volume purification is desired, preferred purification systems will include a relatively large first membrane surface area. Where auxiliary pressure can be applied (or where the speed of fluid purification is not critical), thicker membranes may be employed to achieve other desirable properties such as increased mechanical stability.

In preferred devices, the osmotically active agent comprises a polymer, and the second membrane comprises a membrane that presents a selective barrier to the osmotically active agent (e.g., an ultrafiltration membrane). Fluid (e.g., water) flux through the membranes may be enhanced using an electronic actuator (e.g., electrode assembly, piezoelectric element, etc.). The permeate compartment may also comprise a hydrophilic material (most preferably with sponge-like elasticity). Suitable devices may be arranged in various configurations as noted herein, however, spiral or sandwich configurations are advantageous.

Alternatively, however, it should be recognized that the configurations and methods need not be limited to forward osmosis membranes as described above, and numerous modifications may be made without departing from the inventive concept presented herein. Among other things, the pore size of the membrane and the type of membrane used may vary considerably. For example, where the fluid source is known to be biologically safe (e.g., no significant content of toxins, bacteria, and/or viruses, prefiltered, or otherwise pretreated water), the average pore size may be increased to increase the fluid transfer rate across the membrane. Such systems may then have a forward osmosis membrane with an average pore size between about 1 nm and 100 nm. In another example, and especially where a water feed source has a relatively high content of finely dispersed material, additional membranes or other materials may be fluidly coupled to the forward osmosis membrane to prevent mechanical damage to the forward osmosis membrane. In this regard, any of the pre-filtering process operations and/or devices known in the art for pre-treating feed sources may be combined with the present invention as needed, depending on the type of feed, the membranes utilized and the osmotically active agent.

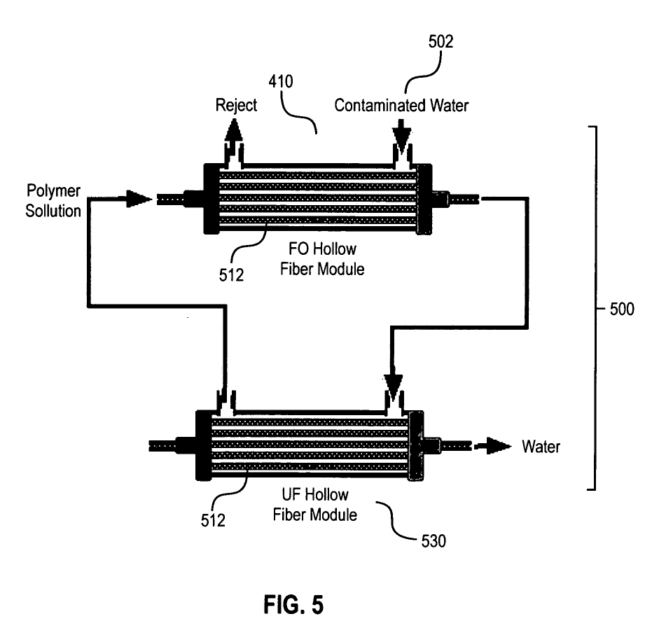

FIG. 5 depicts a schematic configuration 500 in which forward osmosis hollow fiber module 510 and an ultra-filtration hollow fiber module 530 are fluidly coupled to each other. The forward osmosis hollow fiber module 510 includes a polymer 512 as osmotically active agent inside the hollow fibers, and contaminated or otherwise spoilt water 502 surrounds the hollow fibers. The ultra-filtration hollow fiber module include polymer electrolyte 512 outside the hollow fibers and clean water permeates inside the hollow fibers. The polymer is transported from the forward osmosis module to the ultrafiltration module by a mechanical pump (not shown), pneumatic devices, or other mechanical devices or gravity feed such that sufficient pressure is generated inside the ultrafiltration hollow fibers for pure water to permeate into the hollow fibers of the ultrafiltration module.

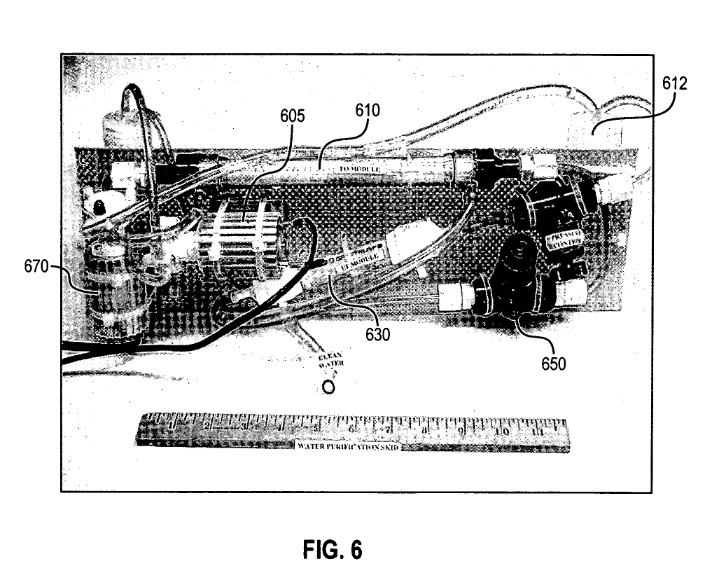

FIG. 6 is a model of an exemplary portable fluid (water) purification system prototype developed based on the general concept of FIG. 5. The prototype contains a contaminated or otherwise spoilt water reservoir 602. Contaminated fluid such as water is pumped from reservoir 602 by pump 605 through the forward osmosis hollow fiber module 610. Pump 670 transports the polymer (osmotically active agent) from its reservoir 612 through the forward osmosis hollow fiber module 610. The water is osmotically transported from contaminated fluid side to the polymer side under osmotic force. The permeate passes through the ultrafiltration hollow fiber module 630. The pressure control valve 650 adjusts the pressure in the ultrafiltration hollow fiber module such that enough pressure is generated inside the ultrafiltration hollow fiber module for the pure water to permeate through the ultrafiltration hollow fibers.

In yet another example, suitable forward osmosis membranes may carry additional functional moieties, and especially suitable moieties include electrically charged groups (e.g., tertiary amine groups for positive charge, sulfonate groups for negative charge, chelating, or otherwise complexing moieties with or without ion-selectivity (e.g., EDTA as non-specific chelator, NTA as nickel-specific chelator, etc.), and protective groups (or coatings) that reduce or even prevent formation of a biofilm, fouling, or other microbial contamination.

In yet another example, waste water from industrial sources (e.g., sewer waste, urine, city water waste, brackish water, condensed exhaust of internal combustion engines, condensed exhaust from chimneys, etc.) may be used as source of contaminated water for purification or waste disposal by concentrating waste by water removal. Other suitable applications include the recovery of valuable products from the mine waste water in addition to water purification, as well as concentrating juices, concentrating milk for soft cheese manufacture, concentrating blood serum, and solvent or volatile organic recovery.

Still further, the first membrane may be coupled to the device in numerous manners, and in one preferred aspect of the inventive subject matter, the forward osmosis membrane is laminated (or otherwise coupled) along an outer perimeter to the second membrane for the osmosis compartment. Alternatively, the first membrane may also be coupled to a housing, frame, or otherwise supporting structure to form part of the osmosis compartment.

As described herein, the first membrane is advantageously a forward osmosis membrane. In addition to a forward osmosis membrane, the first membrane may also be a membrane selected from microfiltration, ultrafiltration, nanofiltration, reverse osmosis, pervaporation, dialysis, electrodialysis, membrane distillation, osmotic distillation, and combinations thereof.

The second membrane may also be selected from all known membranes suitable for use herein so long as such membranes at least temporarily retain the osmotically active agent in the osmosis compartment, and allow passage of the fluid through the second membrane upon application of a suitable force. Suitable second membranes include, e.g., microfiltration, ultrafiltration, nanofiltration, reverse osmosis, pervaporation, dialysis, electrodialysis, membrane distillation, osmotic distillation, and combinations thereof. However, it is preferred that the second membrane comprises an ultrafiltration membrane with an average pore size of between 1 nm and 100 nm. There are numerous ultrafiltration membranes known in the art (e.g., Millipore membranes), and all of the known ultrafiltration membranes are suitable for use herein. Alternatively, or additionally, suitable second membranes also include multilayer polyionic membranes, and/or polymer electrolyte sol-gel composite membranes.

In another aspect, suitable membranes include those having a pore size through which water can be forced from the osmosis compartment using mechanical force, and most preferably manual force, while retaining the osmotically active agent. Therefore, suitable second membranes also include filters, frits, and other porous materials. Consequently, suitable materials for the second membrane may vary considerably, and include natural and synthetic polymers, glass, carbon fibers, foamed materials, etc. Still further, and especially where the osmotically active agent is covalently (or otherwise in at least temporarily non-removable form) coupled to the forward osmosis membrane, the average pore size of the second membrane may exceed the spatial dimensions of the osmotically active agent.

In another aspect of the invention, the first and second membrane may independently be selected from hydrophilic and/or hydrophobic membranes, including hydrophilic and/or hydrophobic polymeric membranes known in the art. The various categories and types of polymers that may be utilized, of course, depend in part on the particular fluid or other component to be separated and are not detailed further herein. It is nonetheless within the scope of the invention that any such hydrophilic and/or hydrophobic membranes may be utilized as the first and/or second membranes.

Regardless of the specific nature of the second membrane (or membrane assembly), the fluid purification systems may include an electronic actuator that effects oscillating or otherwise irregular movement of the water in the system. Such movement of water in the system may advantageously reduce or even eliminate clogging or other obstruction of the reverse osmosis and/or second membrane. For example, suitable electronic actuators will include piezoelectric elements that are coupled to the second membrane or membrane assembly. Alternatively, at least one of the membranes may be coupled to a cathode and/or anode that receives electric pulses forcing the membranes together and thereby providing a vibrational movement of the water column that is fluidly coupled to the electrode(s). Various experiments have indicated that such electrodes may be effectively actuated using a 0.8V pulse (e.g., with on:off ratio of 1:5) at a frequency of up to 1000 Hz at minimal charge leakage. Other means of reducing clogging or fouling of the first and second membranes may be utilized as well, without limitation, including the use of turbulence generators, or the use of pre-filters and pre-filtration process operations, as noted previously.

Preferred osmotically active agents include solid polymers (e.g. polymer electrolytes) in which an ionic species, and with that an osmotically active species, is dissolved by a polymer (e.g., potassium thiocyanante complexed in poly(ethylene oxide)). Alternatively, suitable polymers also include those in which one or more ionic species are covalently coupled to a polymeric backbone or side chain of the backbone (see e.g., U.S. Pat. Nos. 5,312,895 and 5,312,876, both to Dang). Further preferred suitable polymers may be soluble in water, or may have crosslinks between the polymeric strands as described by Helmer-Metzmann in U.S. Pat. No. 5,741,408. Particularly preferred polymers include those based on polysiloxanes and poly (alkylene oxides) as described by Narang et al. in U.S. Pat. Nos. 5,548,055 and 5,633,098. It should still further be appreciated that the number of ionic groups in preferred polymers is preferably relatively high and that the type of charge (i.e., positive or negative charge) is preferably homogeneous throughout the polymer electrolyte. Advantageously, the polymer may be selected from alkali-neutralized polymers, polyethyleneimine hydrochloride, polyalkylene glycol, polyvinyl alcohol, alkylene oxide polymers, polyacryloxy glucose, and copolymers and combinations thereof. Suitable alkali-neutralized polymers include alkali-neutralized polystyrene sulfonate, alkali-neutralized polyvinyl sulfonate, alkali-neutralized polyitaconate, alkali-neutralized polyacrylates, and the like, while suitable polyalkylene glycols include polyethylene glycol and/or polypropylene glycol. Suitable alkylene oxide polymers include ethylene oxide and propylene oxide polymers and copolymers thereof such as Pluronic® F68 ethylene oxide/propylene oxide copolymers.

The polymer may also be linear, e.g., straight chain, or branched, including dendrimeric. Other structural forms such as block copolymers may also be utilized.

In preferred aspects of the inventive subject matter, the osmotically active agent comprises a polymer with an average molecular weight in the range of about 5 kD to about 200 kD, more typically about 10 kD to about 100 kD, and even more typically about 20 kD to about 50 kD. The polymer may provide numerous ionic groups that act as osmotically active agents while at the same time also providing a scaffold that helps block migration of the osmotically active agent in the permeate compartment and/or inseparable dissolution of the osmotically active agent.

Alternatively, the osmotically active agent may also include a salt in which at least one of the cation and anion has a relatively high molecular weight to reduce migration of the ion across the second membrane. Therefore, suitable salts will most typically include organic salts (e.g., those comprising polycationic and polyanionic peptides). Alternatively, where the osmotically active agent comprises an inorganic salt, it is generally preferred that at least one of the cationic and anionic portion of the salt can be precipitated (e.g., by temperature decrease, or addition of counter ion to form highly insoluble salt) or otherwise removed (e.g., via chelation or electrodeposition) from the fluid in the osmosis compartment.

Independent of the particular nature of the osmotically active agent, it should be appreciated that the fluid that has accumulated in the osmosis compartment can be removed from the osmosis compartment through the second membrane using only relatively moderate forces (depending on the scale of the membrane separation system, of course), which are predominantly determined by the size, type and configuration of the second membrane or membrane assembly. For example, where the osmotically active agent comprises a relatively high-molecular weight polymer, the second membrane may have an average pore size of between 50 nm to 500 nm, which significantly facilitates transport of the fluid across the second membrane. Typically, in small scale devices, pressures required for water transport can be easily achieved by manual force (e.g., between about 20-100 psi). The use of alternative mechanical and pneumatic forces is also possible, however, particularly for larger scale systems, including mechanical compression of the osmosis compartment, application of a reduced pressure to the permeate compartment and/or the application of elevated pressure on the osmosis compartment. In yet further aspects of the invention, and especially where an electronic actuator is included in the fluid purification system, electroosmotic fluid transport may also be used. Alternatively, or in addition, capillary force may be employed to transport fluid across the second membrane or membrane assembly.

The fluid forced across the second membrane or membrane assembly may then be collected in a permeate compartment, which may be open-ended (i.e., having no other confining wall other than the second membrane or membrane assembly), or which may form an independent compartment. Regardless of the particular configuration of the permeate compartment, it is generally preferred that at least a portion of the fluid that is transported across the second membrane or membrane assembly be received in a (preferably hydrophilic) receiving material. Such material may advantageously act as a sponge and may further provide at least part of the force to transport the fluid from the osmosis compartment to the permeate compartment. There are numerous hydrophilic polymeric materials known in the art, all of which are considered suitable for use herein. However, particularly preferred materials include porous silicon-based materials (e.g., generated with nitrogen-generating blowing agent), hydrogels (e.g., formed from polymer electrolytes such as crosslinked polystyrene sulfonate with porogen), or substituted hydrogels (e.g., controlled upper/lower critical solution temperature).

The fluid (water) purification systems can be fabricated in a continuous fashion using a multistation printer (e.g., Comco Multistation Printer). For example, where the fluid purification system has a multilayer configuration as depicted in FIG. 4, a printing system with multiple printing stations, embossing, and laminating stations may be employed in which microchannels are created by an embossing station, in which a membrane-electrode assembly (as depicted in FIG. 2) is generated by screen printing of silver impregnated carbon electrodes and subsequent coating of the cationic membrane to one side of the assembly. The hydrophilic material may then be generated on the permeate side by in situ curing, and where appropriate, a spacer may be laminated onto the system before the multi-layer water purification system is assembled into a stack or rolled configuration to provide increased turbulence and thereby help to keep the membrane clean or unclogged.

The fluid purification systems according to the invention are especially suitable as portable water purification devices, in which multiple layers of water purification systems cooperate to increase the surface exposure of the forward osmosis membrane to the water source (typically contaminated water), and in which at least part of the device is compressed by the user to obtain clean water. For example, where the device is configured into a spiral (e.g., having soda can proportions), the user may retrieve purified water by compressing the device in his or her hand. Of course, it should be recognized that in such devices the permeate compartment is temporarily sealed off to prevent influx of contaminated water into the permeate compartment. Thus, in at least some aspects of the invention, the membrane systems and devices may be used in a discontinuous fashion.

Continuous use is also contemplated, however. For example, where a device comprising a water purification system is submerged in a body of contaminated water or sea water, it should be appreciated that the device may be moved in the body of contaminated water or sea water, and wherein wave action or other movement of the water may be employed to temporarily compress the device (or portion thereof) for extraction of the purified water from the osmosis compartment and/or permeate compartment.

As detailed above, the invention provides a water purification system in which a forward osmosis membrane is fluidly coupled to a second membrane, wherein water is moved through the forward osmosis membrane using the osmotic force of an osmotically active agent disposed between the forward osmosis membrane and the second membrane, and wherein water is forced from the osmotically active agent and moved through the second membrane using hydraulic or mechanical force. In preferred systems, a forward osmosis membrane separates a fluid source from an osmosis compartment comprising an osmotically active agent, and a second membrane separates the osmosis compartment from a permeate compartment, wherein the osmotically active agent provides sufficient osmolarity to move fluid from the fluid source through the forward osmosis membrane to the osmosis compartment, and wherein the second membrane is configured to allow passage of the fluid from the osmosis compartment to the permeate compartment while retaining the osmotically active agent.

While specific embodiments and applications of fluid, especially water, purification systems have been mentioned herein, it should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. For example, the terms “comprises” and “comprising” should be interpreted as referring to elements, components, or steps in a non-exclusive manner, indicating that the referenced elements, components, or steps may be present, or utilized, or combined with other elements, components, or steps that are not expressly mentioned or recited.

It is to be understood that while the invention has been described in conjunction with the preferred specific embodiments thereof, that the foregoing description is intended to illustrate and not limit the scope of the invention. Other aspects, advantages and modifications within the scope of the invention will be apparent to those skilled in the art to which the invention pertains.

All patents, patent applications, and publications mentioned herein are hereby incorporated by reference in their entireties.

We claim:

1. A membrane system for the purification of a fluid comprising a first semi-permeable membrane fluidly coupled to a second semi-permeable membrane, wherein fluid is moved through the first membrane by the osmotic force of an osmotically active agent disposed between the first membrane and the second membrane, and wherein the fluid is forced from the osmotically active agent and moved through the second membrane.

2. The membrane system of claim 1 wherein the fluid comprises water.

3. The membrane system of claim 1 wherein the osmotically active agent comprises a polymer.

4. The membrane system of claim 2 wherein the polymer has a molecular weight in the range of about 5 kD to about 200 kD.

5. The membrane system of claim 2 wherein the polymer has a molecular weight in the range of about 10 kD to about 100 kD.

6. The membrane system of claim 2 wherein the polymer has a molecular weight in the range of about 20 kD to about 50 kD.

7. The membrane system of claim 3 wherein the polymer is selected from alkali-neutralized polymers, polyethyleneimine hydrochloride, polyalkylene glycol, polyvinyl alcohol, alkylene oxide polymers, polyacryloxy glucose, and copolymers and combinations thereof.

8. The membrane system of claim 7 wherein the polymer is selected from alkali-neutralized polystyrene sulfonate, alkali-neutralized polyvinyl sulfonate, alkali-neutralized polyitaconate, alkali-neutralized polyacrylates, polyethyleneimine hydrochloride, polyethylene glycol, polyvinyl alcohol, ethylene oxide/propylene oxide polymers, polyacryloxy glucose, and copolymers and combinations thereof.

9. The membrane system of claim 1 wherein the first membrane comprises a membrane selected from forward osmosis, microfiltration, ultrafiltration, nanofiltration, reverse osmosis, pervaporation, dialysis, electrodialysis, membrane distillation, osmotic distillation, and combinations thereof.

10. The membrane system of claim 1 wherein the first membrane is a forward osmosis membrane.

11. The membrane system of claim 1 wherein the second membrane comprises a membrane selected from microfiltration, ultrafiltration, nanofiltration, reverse osmosis, pervaporation, dialysis, electrodialysis, membrane distillation, osmotic distillation, and combinations thereof.

12. The membrane purification system of claim 1 further comprising an actuator coupled to the first and/or second membrane, wherein the actuator functions to reduce or eliminate fouling or clogging of the first and/or second membrane.

13. The membrane system of claim 1 further comprising a hydrophilic material that is coupled to the second membrane and receives at least part of the fluid that passes through the second membrane.

14. The membrane system of claim 1 wherein the fluid is forced from the osmotically active agent and passed through the second membrane by mechanical force.

15. The membrane system of claim 14 wherein the mechanical force comprises manual force.

16. The membrane system of claim 1 wherein the first and second membranes are independently selected from flat, hollow-fiber or composite membranes, and further wherein the first and second membranes are independently or together arranged in a spiral, flat plate, or sandwich configuration.

17. A membrane system for the purification of a fluid, comprising:
a first semi-permeable membrane;
an osmosis compartment comprising an osmotically active agent, wherein the first membrane separates a fluid source from the osmosis compartment;
a second semi-permeable membrane that separates the osmosis compartment from a permeate compartment;
wherein the osmotically active agent provides sufficient osmolarity to move fluid from the fluid source through the forward osmosis membrane to the osmosis compartment; and
wherein the second membrane allows the fluid from the osmosis compartment to pass to the permeate compartment while retaining the osmotically active agent.

18. The membrane purification system of claim 17 wherein the fluid comprises water.

19. The membrane purification system of claim 17 wherein the osmotically active agent comprises a polymer.

20. The membrane purification system of claim 19 wherein the polymer has a molecular weight in the range of about 5 kD to about 200 kD.

21. The membrane purification system of claim 19 wherein the polymer has a molecular weight in the range of about 10 kD to about 100 kD.

22. The membrane purification system of claim 19 wherein the polymer has a molecular weight in the range of about 20 kD to about 50 kD.

23. The membrane purification system of claim 17 wherein the polymer is selected from alkali-neutralized polymers, polyethyleneimine hydrochloride, polyalkylene glycol, polyvinyl alcohol, alkylene oxide polymers, polyacryloxy glucose, and copolymers and combinations thereof.

24. The membrane purification system of claim 23 wherein the polymer is selected from alkali-neutralized polystyrene sulfonate, alkali-neutralized polyvinyl sulfonate, alkali-neutralized polyitaconate, alkali-neutralized polyacrylates, polyethyleneimine hydrochloride, polyethylene glycol, polyvinyl alcohol, ethylene oxide/propylene oxide polymers, polyacryloxy glucose, and copolymers and combinations thereof.

25. The membrane purification system of claim 17 wherein the first membrane comprises a membrane selected from forward osmosis, microfiltration, ultrafiltration, nanofiltration, reverse osmosis, pervaporation, dialysis, electrodialysis, membrane distillation, osmotic distillation, and combinations thereof.

26. The membrane purification system of claim 17 wherein the first membrane is a forward osmosis membrane.

27. The membrane purification system of claim 17 wherein the second membrane comprises a membrane selected from microfiltration, ultrafiltration, nanofiltration, reverse osmosis, pervaporation, dialysis, electrodialysis, membrane distillation, osmotic distillation, and combinations thereof.

28. The membrane purification system of claim 17 further comprising an actuator coupled to the first and/or second membrane, wherein the actuator functions to reduce or eliminate fouling or clogging of the first and/or second membrane.

29. The membrane purification system of claim 17 further comprising a hydrophilic material disposed in the permeate compartment and receiving at least part of the fluid that passes through the second membrane.

30. The membrane purification system of claim 17 wherein the fluid is forced from the osmosis compartment to the permeate compartment using mechanical force.

31. The membrane purification system of claim 17 wherein the first and second membranes are independently selected from flat, hollow-fiber or composite membranes, and further wherein the first and second membranes are independently or together arranged in a spiral, flat plate or sandwich configuration.

32. A method of purifying a fluid, comprising
forcing fluid from a fluid source through a first membrane into an osmosis compartment using the osmotic force of an osmotically active agent; and
forcing the fluid from the osmosis compartment through a second membrane into a permeate compartment while retaining the osmotically active agent in the osmosis compartment.

33. The method of claim 32 wherein the fluid comprises water.

34. The method of claim 32 wherein the osmotically active agent comprises a polymer.

35. The method of claim 34 wherein the polymer has a molecular weight in the range of about 5 kD to about 200 kD.

36. The method of claim 34 wherein the polymer has a molecular weight in the range of about 10 kD to about 100 kD.

37. The method of claim 34 wherein the polymer has a molecular weight in the range of about 20 kD to about 50 kD.

38. The method of claim 34 wherein the polymer is selected from alkali-neutralized polymers, polyethyleneimine hydrochloride, polyalkylene glycol, polyvinyl alcohol, alkylene oxide polymers, polyacryloxy glucose, and copolymers and combinations thereof.

39. The method of claim 38 wherein the polymer is selected from alkali-neutralized polystyrene sulfonate, alkali-neutralized polyvinyl sulfonate, alkali-neutralized polyitaconate, alkali-neutralized polyacrylates, polyethyleneimine hydrochloride, polyethylene glycol, polyvinyl alcohol, ethylene oxide/propylene oxide polymers, polyacryloxy glucose, and copolymers and combinations thereof.

40. The method of claim 32 wherein the first membrane comprises a membrane selected from forward osmosis, microfiltration, ultrafiltration, nanofiltration, reverse osmosis, pervaporation, dialysis, electrodialysis, membrane distillation, osmotic distillation, and combinations thereof.

41. The method of claim 32 wherein the first membrane is a forward osmosis membrane.

42. The method of claim 32 wherein the second membrane comprises a membrane selected from microfiltration, ultrafiltration, nanofiltration, reverse osmosis, pervaporation, dialysis, electrodialysis, membrane distillation, osmotic distillation, and combinations thereof.

43. The method of claim 32 wherein the fluid is forced from the osmosis compartment through the second membrane into a permeate compartment by the application of mechanical force.
